(19) United States
(12) Patent Application Publication
(10) Pub. No.: US 2020/0151474 A1
(43) Pub. Date: May 14, 2020

(54) NON-INTRUSIVE ASSESSMENT OF FATIGUE IN DRIVERS USING EYE TRACKING

(71) Applicant: Alcohol Countermeasure Systems (International) Inc., Toronto (CA)

(72) Inventors: Ali Shahidi Zandi, Toronto (CA); Min Liang, Montreal (CA); Azhar Quddus, Toronto (CA); Laura Prest, Toronto (CA); Felix J.E. Comeau, Toronto (CA)

(21) Appl. No.: 16/529,444

(22) Filed: Aug. 1, 2019

Related U.S. Application Data
(63) Continuation-in-part of application No. 16/050,788, filed on Jul. 31, 2018, now abandoned.
(60) Provisional application No. 62/539,064, filed on Jul. 31, 2017.

(51) Int. Cl. G06K 9/00; G06F 3/01; G06K 9/62

(52) U.S. Cl. CPC G06K 9/00845; G06K 9/6269; G06K 9/00604; G06F 3/013

(57) ABSTRACT

Non-intrusive assessment of fatigue in drivers using eye tracking. In a simulated driving experiment, vigilance was assessed by power spectral analysis of multichannel electroencephalogram (EEG) signals, recorded simultaneously, and binary labels of alert and drowsy (baseline) were generated for each epoch of the eye tracking data. A classifier and a non-linear support vector machine were employed for vigilance assessment. Evaluation results revealed a high accuracy of 88% for the RF classifier, which significantly outperformed the SVM with 81% accuracy (p<0.001). In a simulated driving experiment, the simultaneously recorded multichannel electroencephalogram (EEG) signals were used as the baseline. A random forest (RF) and a non-linear support vector machine (SVM) were employed for binary classification of the state of vigilance. Different lengths of eye tracking epoch were selected for feature extraction, and the performance of each classifier was investigated for every epoch length. Results revealed a high accuracy for the RF classifier in the range of 88.37%-91.18% across all epoch lengths, outperforming the SVM with 77.12%-82.62% accuracy. A feature analysis approach was presented and top eye tracking features for drowsiness detection were identified. A high correspondence was identified between the extracted eye tracking features and EEG as a physiological measure of vigilance and verified the potential of these features along with a proper classification technique, such as the RF, for non-intrusive long-term assessment of drowsiness in drivers.

### CROSS REFERENCE TO RELATED APPLICATION

This application is a continuation-in-part application of U.S. patent application Ser. No. 16/050,788, filed Jul. 31, 2018 and entitled NON-INTRUSIVE ASSESSMENT OF FATIGUE IN DRIVERS USING EYE TRACKING which claims the benefit of U.S. Provisional Patent Application Ser. No. 62/539,064, filed Jul. 31, 2017 and entitled NON-INTRUSIVE ASSESSMENT OF FATIGUE IN DRIVERS USING EYE TRACKING.

### BACKGROUND OF THE INVENTION

### 1. Field of the Invention

Due to life style and work requirements, people are more susceptible to fatigue than ever before. Sleep loss, irregular working schedule (e.g., shift work), and extended periods of time spent on a regular and monotonous task such as driving (i.e., time-on-task) are among common factors leading to fatigue, drowsiness, and/or cognitive deficits. Research indicates that one gets 20% less sleep, on average, comparing to a century ago (1), while it is estimated that about 50-70 million Americans suffer from sleep disorders (2). Fatigue can have serious consequences for people health and safety and can negatively affect performance and quality of life. In particular, driver performance depreciates significantly under the influence of fatigue, which is more pronounced in the presence of sleep restriction (3,4), resulting in higher risk of motor vehicle collisions.

The National Highway Traffic Safety Administration estimates that 72,000 police-reported motor vehicle accidents in 2015 involved drowsy driving, while these crashes resulted in 41,000 injuries and 800 deaths (5). In a broader estimate, it is reported that 16.5% of all fatal collisions (and 7% of all crashes) on US roadways involve drowsy drivers (5). The Traffic Injury Research Foundation reported that 6.4% of Canadian motor vehicle fatalities were drowsy-related in 2013 (6). In a survey of Canadian drivers in 2011, 18.5% of participants admitted to falling asleep or nodding off at some point behind the wheel (6).

Consequently, the long-term monitoring of driver vigilance as a countermeasure for managing fatigue is critical in order to reduce the risk of motor vehicle collisions and improve road safety. Despite extensive research in the past, development of reliable non-intrusive technologies for real-time monitoring of drowsiness and fatigue in drivers has remained challenging.

### 2. Prior Art

Overall, the influence of fatigue and drowsiness in drivers can be objectively measured using physiological responses (7-13), driver behavioural patterns (14-21), and/or driving performance (4,16,22-25), among which physiological responses, such as electroencephalogram (EEG), electrocardiogram (ECG) or electro-oculagram (EOG) produce more reliable measures with very high temporal resolution necessary to detect subtle changes in vigilance well in advance of behavioural lapses. However, due to their intrusive nature, the application of techniques based on such measures are limited for long-term driver monitoring in real-world conditions. In a recent study (13), EEG features from multiple independent brain sources were integrated, where the reaction time was used a baseline for vigilance. An average classification accuracy of 88% was reported using this approach. Shuyan and Gangtie (11) employed a support vector machine (SVM) for drowsiness detection in 37 sleep-deprived drivers using eyelid features extracted from EOG and assessed the performance based on subjective reports. Khushaba et al. proposed a wavelet-based technique to extract features from EEG, EOG and ECG to detect drowsiness (10). These features were tested in combination with different classifiers such as SVM, linear discriminant analysis and k-nearest neighbours, resulting in 95%-97% accuracy across all subjects.

As opposed to physiological responses, measures relying on driver behavioural patterns, such as eye movements and facial expressions, are non-intrusive and more applicable for long-term monitoring of drowsiness. The main challenge for these types of measures, however, is the accuracy and reliability of the measurements. For example, lighting conditions can influence the performance of an eye-tracking-based system. Percentage of eyelid closure (PERCLOS) is a measure used in several studies and defined as the percentage of time that eyes are closed for a minimum level, e.g. at least 80% closed (20,22,26). Jackson et al. (15) studied the influence of sleep loss on PERCLOS, in a simulated driving task, observing that sleep deprivation significantly increase PERCLOS. Some studies, however, reported a noticeably lower accuracy for PERCLOS, compared to techniques based on biological signals (26).

A major limitation of PERCLOS is its dependency on the length of the time window used to compute the measure. Large time intervals would be required to provide good prediction (28), resulting in a noticeable delay for drowsiness detection (19). Moreover, subject blinking patterns affect PERCLOS performance (28) and the method can fail in case of drivers falling asleep with eyes open (19). In some studies, PERCLOS has been used along with other measures. Bergasa et al. (19) observed that the delay between the moment that system detected the drowsiness and the actual onset of drowsiness increased if only PERCLOS was used, while the fixed gaze features reduced the detection latency. Some other studies (17,29) used facial features such as yawning to detect fatigue.

Driving performance indicators, such as steering wheel patterns, lateral position, or braking patterns have also been used to assess drowsiness in drivers. While this type of information can be collected non-intrusively using vehicle embedded sensors, the accuracy of methods relying on these measures can be affected by several factors such as road/weather conditions, driver experience level and even vehicle model. In (24), using various combinations of acceleration (lateral and longitudinal) and steering wheel angle in a driving simulator study, an accuracy of ˜85% for detection of drowsiness using a random forest (RF) classifier was achieved. In a recent study (16), several driving performance measures along with eye tracking information were used to estimate the drowsiness level. An artificial neural network and a logistic model were used for classification, resulting in 88% and 83% accuracy respectively.

### SUMMARY OF THE INVENTION

Although various methodologies have been proposed for assessment of drowsiness in drivers in the past, these techniques generally suffer from several limitations. Often drowsiness/fatigue is detected with a long delay that negatively influences the effectiveness of these methods to prevent motor vehicle accidents. Many are not robust enough against environmental and driving conditions, while some others are intrusive; hence not appropriate for long-term monitoring. In some studies, the performance of the proposed technologies has been poorly evaluated using unreliable baselines.

The objective of this research is to study the characteristics of eye tracking data as a non-intrusive measure of driver behaviour, which would ultimately lead to development of a reliable technology for real-time monitoring of the state of vigilance in drivers, as an imperative action towards improving road safety by managing fatigue in motorists. In (30,31), the authors previously studied the performance of some characteristics of eye movements and blinking for drowsiness assessment using a well-characterized psychomotor vigilance task (PVT), observing a high correspondence between the eye tracking features and the reaction time to visual stimuli (as an objective measure of vigilance) during a prolonged period of time. Moreover, using a small group of subjects, the authors assessed the performance of these eye tracking characteristics against an EEG baseline in a preliminary simulated driving study (31).

This paper investigates the performance of a specific set of thirty-four eye tracking features for drowsiness detection using advanced machine learning techniques in a group of volunteers, participating in a simulated driving task. The simultaneously recorded EEG was used as the baseline in this study. The experiment has been designed in a specific way to induce mild drowsiness/fatigue, providing the opportunity for identification of drowsiness in early stages. In Materials and Methods, the paper describes the driving simulator experiment and methodologies used to collect and process the multimodal data, extract features and classify the observations. Then, results of the study are presented in Experimental Results section, and the paper is finally concluded by Discussion and Conclusion section, providing some discussions and directions for future work.

### BRIEF DESCRIPTION OF THE DRAWINGS

FIG. 1 illustrates schematic diagrams of the eye-tracking-based drowsiness detection methodology: (a) Extracting q features (here, 34) from all epochs (n) of eye tracking data in a given driving session of one subject and determining corresponding labels (baseline) using EEG, (b) Training and testing the classifier;

FIG. 2 illustrates charts of performance distribution for the SVM and RF classifiers: (a) Accuracy, (b) Sensitivity, (c) Specificity;

FIG. 3 illustrates charts of overall performance of the SVM and RF classifiers while dropping features with lower importance: (a) Accuracy, (b) Sensitivity, (c) Specificity;

FIG. 4 illustrates a chart of the eye tracking features;

FIG. 5 illustrates a chart of the state of vigilance classification results for each subject;

FIG. 6 illustrates charts of overall performance of the SVM and RF classifiers for different epoch lengths: (a) Accuracy, (b) Sensitivity, (c) Specificity;

FIG. 7 illustrates charts of Accuracy across all subjects using different epoch lengths: (a) SVM and (b) RF.

FIG. 8 illustrates charts of overall performance of the SVM and RF classifiers for the epoch lengths of 30 sec., while dropping features with lower importance: (a) Accuracy, (b) Sensitivity, (c) Specificity;

FIG. 9 illustrates a chart of the eye tracking features; and

FIG. 10 illustrates a chart of the top 10 eye tracking features for the epoch length of 30 sec.

### DETAILED DESCRIPTION OF THE PREFERRED EMBODIMENTS

### Materials and Methods

This section provides details of the driving simulator experiment conducted in this study and explains the eye tracking feature extraction, classifiers used for drowsiness detection, and processing of EEG data as the baseline.

### Driving Simulator Experiment

This experiment was designed and conducted at the Somnolence Laboratory of Alcohol Countermeasure Systems Corp. (ACS), Toronto, Canada, in order to induce mild levels of drowsiness and fatigue in volunteers, participating in a simulated driving task, and to study the influence of the corresponding changes in the state of vigilance on driver visual behavioural patterns and physiological responses.

### Subjects

Twenty-five volunteers (6 females, 19 males) with the mean (±standard deviation) age of 40.72 (±8.81) years completed the simulated driving experiment. All participants were given a written description summary of the objectives, procedures, and potential risks of the study as well as their rights and privacy. Each subject provided a written consent before participating in the study.

All subjects participated in a trial session at the beginning of the experiment to make sure they were familiar with the procedure and were able to operate the driving simulator appropriately. The subjects were permitted to wear glasses and contact lenses as they would require for normal driving.

### Multimodal Data Collection

The experiment was conducted using the SimuRide PE-3 driving simulator with three 22″ high-definition monitors, providing a wide angle of view for the driver.

The SmartEye Pro 6.0 eye tracking system with two infrared cameras was mounted on the driving simulator to capture eye gaze, eye position, eyelid, blinking and pupilometry data of drivers, while the system was calibrated at the beginning of each driving session. The eye tracking system frame rate was 60 Hz, and the system delivered fixation and saccade labels for the eye gaze, measured at the accuracy of 0.5 degrees. In this experiment, the EEG was recorded simultaneously with the eye tracking data using the Emotiv EPOC+headset with 14 channels at the sampling frequency of 128 Hz, while the EPIC sensor by Plessey was utilized to acquire one-lead ECG data at the rate of 500 Hz.

In each driving session, subjective and objective assessments of vigilance were performed before and after the driving episode. For subjective assessment of vigilance, the Karolinska sleepiness scale (32,33) as a well-known subjective measure of sleepiness was used. A 5-min PVT trial (34-36) was also adopted to get the objective assessment of vigilance.

### Procedure

In this experiment, subjects were asked to participate in two counterbalanced driving sessions held on different days in a random order: one control (CD) and one monotonous (MD) driving session. Both sessions included driving on a low-traffic highway. The CD session was 10-min long and was held in late morning (around 10 am) when the participant was highly alert. Subjects were allowed to engage in conversation with the experimenter without any restrictions on the speed and driving style, such as changing lanes or taking a turn using bridges, in order to reduce the chance of fatigue and boredom. On the other hand, the MD session was designed in a way to induce mild levels of fatigue and drowsiness.

First, in the MD session, participants were required to drive for a noticeably longer period of time (i.e., 30 minutes) under monotonous driving conditions on a low-traffic highway. Second, the driver was not allowed to communicate with the experimenter and needed to comply with the speed limit of 120 km/h (˜75 mph) and follow specific traffic rules (e.g. pulling over, taking turns and changing lanes were not permitted). Third, the MD session was conducted at the mid-afternoon dip of the alertness circadian cycle, typically around 2 pm (after lunch), in order to increase the chance of drowsiness and fatigue. Finally, all participants refrained from drinking coffee and tea for at least two hours before the driving session. It is worth mentioning that the subjects were not put under any forms of sleep deprivation in this study.

### Eye Tracking Feature Extraction

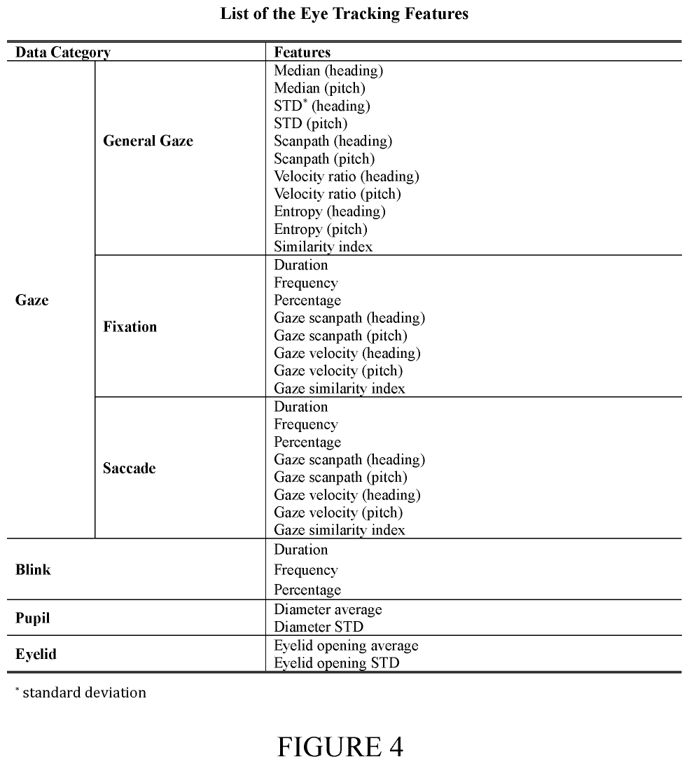

The infrared-based eye tracking system used in this study collected multidimensional data, including various eye measurements, from drivers in each driving session at the rate of 60 Hz. The eye tracking data were then segmented into 10-sec epochs with 5-sec overlap, and 34 distinct features were extracted from each epoch. FIG. 4 presents the full list of these features, extracted from four main categories of the acquired eye tracking data: eye gaze, blink, pupil, and eyelid. The eye gaze consisted of a two dimensional angular vector: heading (left/right) and pitch (up/down) angles in radian. For feature extraction, the eye gaze data were divided into general gaze, fixation, and saccade. Details of the extracted features are provided in the following.

### Average, Median, and Standard Deviation

Given a specific epoch of the eye tracking data, these three statistics were computed for some eye measurements, e.g. gaze pitch angle or eyelid opening distance, over the entire epoch.

### Duration, Frequency, and Percentage

These features were calculated for fixations, saccades and blinks. Let [symbol] be the time length of the kth incident of a desired eye movement or pattern (e.g. fixation or blinks), where k=1, 2, . . . , M (M is the total number of the incidents), in a given epoch with the time length of L. Then, the duration feature is defined as

$$D = \frac{1}{M} {\sum }_{k = 1}^{M} {𝓁}_{k} \qquad ( 1 )$$

The frequency feature is simply defined as ratio of the total number of incidents of the desired eye movement/pattern to the length of epoch, i.e. M/L. The percentage feature measures the fraction of the epoch including the desired eye movement/pattern:

$$P = \frac{1}{L} {\sum }_{k = 1}^{M} {𝓁}_{k} . \qquad ( 2 )$$

### Scanpath

This feature was calculated based on gaze values in a given epoch and is defined as total movement of eye in a specific dimension. For a set of gaze values {gᵢ^{d}}_{i=1:N}, the scanpath is calculated as

$${λ}^{d} = {\sum }_{i = 2}^{N} \vert {g}_{i ,}^{d} - {g}_{i - 1}^{d} \vert , \qquad ( 3 )$$

where |.| is the absolute value operator, i is the gaze sample number in chronological order, N is the total number of gaze samples, and d is the dimension of gaze (pitch or heading) for which the scanpath is computed.

### Velocity and Velocity Ratio

In case of fixation and saccade data, the average velocity over all incidents of the eye movement (fixation or saccade) in the given epoch was computed for each dimension (heading and pitch) as the velocity feature.

For the general gaze data, however, due to the large variability of the raw velocity, a velocity ratio feature was defined for each dimension in every epoch as

$${ϑ}^{d} = ln ( \frac{{v}_{max}^{d}}{{v}_{median}^{d}} ) , \qquad ( 4 )$$

where ln(.) is the natural logarithm operator, and vₘₐₓ^{d} and V_{medium}^{d} are the peak and median velocities for dimension d of the gaze data respectively.

### Entropy

For each dimension of general gaze data, the differential entropy (38) was computed in each epoch as

$${η}^{d} = - {{\int }_{- ∞}}^{ ∞} \hat{p} ( {g}^{d} ) ln \hat{p } ( {g}^{d} ) , \qquad ( 5 )$$

in which \hat{p}(g^{d}) is the estimated probability density function of the gaze data in dimension d, calculated by kernel techniques (39).

### Similarity Index

For each epoch of the eye gaze data, a similarity index was calculated based on correlation sum measure (40) to assess how concentrated the gaze was during that epoch. Given the set of gaze vectors {gᵢ}_{i=1:N} in the current epoch, where gᵢ=[gᵢ^{h} gᵢ^{p}]^{T} is the ith gaze vector (gᵢ^{h} and gᵢ^{p} are respectively the gaze heading and pitch angles) and Nis the total number of gaze vectors, the similarity index is defined as

$$𝒮 = \frac{2}{N ( N - 1 )} {\sum }_{i = 1}^{N - 1} {\sum }_{j = i + 1}^{N} ℍ ( ɛ - ‖ {g}_{i} - {g}_{j} ‖ ) , \qquad ( 6 )$$

where [symbol] (.) is the Heaviside step function, ∥x∥ is the Euclidean distance, and ε is the neighborhood radius, set to 0.087 radian (5 deg.) in this work.

### Classification

In this study, a non-linear SVM and an RF classifier have been used for binary identification of the state of vigilance, i.e. “alert” and “drowsy”, based on features extracted from the eye tracking data.

### Support Vector Machine (SVM)

SVMs minimize the classification error by maximizing the margin between the closest observations from each class (i.e. support vectors) and the decision boundary (41,42). In case of binary classification using non-linear SVMs, the decision boundary can be presented as a hyperplane Λ^{T}φ(x)+τ=0 in a higher-dimensional space, where Λ is the normal to the hyperplane, τ is a scalar constant, and φ(x) maps the feature vector x into the higher-dimensional space. To find the decision boundary, however, the mapping function φ(x) does not need to be known. That is, by choosing a proper kernel function defined as K(xᵢ,xⱼ)=φ(xᵢ)^{T}φ(xⱼ), the optimization problem can be solved in the original feature space. In this study, a Gaussian kernel function was adopted for the non-linear SVM classifier.

### Random Forest (RF)

RFs are ensemble learning methods (43) for regression, classification or other prediction tasks. An RF classifier is a set of N tree-structured classifiers {h(x,Φₙ), n=1, . . . , N}, where {Φₙ} are independent and identically distributed random vectors. In this ensemble, each member (i.e., tree classifier) casts a vote for the most popular class at input x (44). Generally, the RF algorithm uses N bootstrap replicates of data to train the N different decision trees (in this work, 200). To predict the class of a given data point (i.e., test data point), the majority vote over all the classifiers (trees) is taken.

Individual decision trees may overfit to the training data. Since the RF classifier combines the results of many decision trees, the influence of overfitting is reduced (i.e., decreasing the variance of the model, without increasing the bias) which improves generalization. The accuracy of RF classifiers is better than decision trees, as good as Adaboost (45) and sometimes even better. Given the fact that the predictions are based on the average of many trees, it is relatively more robust to outliers and noise than a single tree. Moreover, RFs provide useful internal estimates of variable importance. Since the training of each tree does not affect the others, the algorithm is simple and can be easily parallelized.

### EEG Signal Processing

In this study, characteristic changes in the EEG power spectrum were analyzed in order to assess the level of drowsiness, e.g. see (7,46,47), and generate corresponding binary labels (i.e., “alert” vs. “drowsy”) for each epoch of the eye tracking data. EEG waveforms in four distinct frequency bands were analyzed (48): the δ-band (0.5-4 Hz), the θ-band (4-7 Hz), the α-band (8-12 Hz), the β-band (13-30 Hz). A 60-Hz notch filter was first applied to the multichannel EEG signal, and the signal was band-passed filtered between 0.2 and 45 Hz. Seven bipolar EEG channels (AF₃-AF₄, F₇-F₈, F₃-F₄, FC₅-FC₆, T₇-T₈,P₇-P₈,O₁-O₂) were then used for power spectral analysis.

In this work, the short-time Fourier transform was applied to EEG channels and the β/α and α/(δ+θ) power ratios were computed for each EEG epoch in every channel. The changes in these statistics were then monitored. The higher the spectral power ratios are, the higher the level of the alertness. Using the EEG data from the first 5 minutes of CD session for each subject as the reference, a binary subject-specific measure of vigilance were computed for each epoch: “alert” (EEG power ratios equal to or greater than the reference) and “drowsy” (EEG power ratios less than the reference).

### Experimental Results

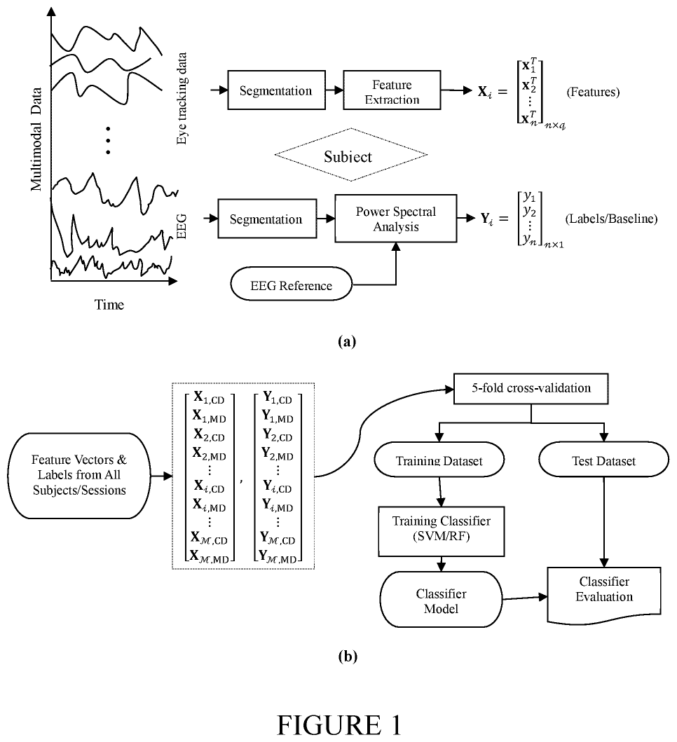

In this section, the results of the proposed eye-tracking-based machine learning method (i.e., binary classification using eye tracking features introduced in FIG. 4) for non-intrusive assessment of the state of vigilance in drivers are presented. FIG. 1 depicts a schematic of the methodology presented.

### Training and Test Datasets

In this study, a 5-fold cross-validation approach was employed to evaluate the performance of the proposed methodology across all subjects. That is, after extracting the 34-dimensional feature vector from each epoch of eye tracking data in both CD and MD sessions for each subject, the extracted feature vectors from all subjects were added together, and the resulting dataset was randomly divided into 5 disjoint subsets (or folds) with roughly equal size. Then, while one fold of the data was kept out as the test set, SVM and RF classifiers were trained using the remaining four folds (i.e., separate training and test datasets), and their performance was assessed using the test fold. The training and test procedures were repeated by choosing another test fold till each fold of data was once used as the test set. The classification results for all folds were, then, combined to determine the performance of the classifier on the entire dataset.

### Classification Results

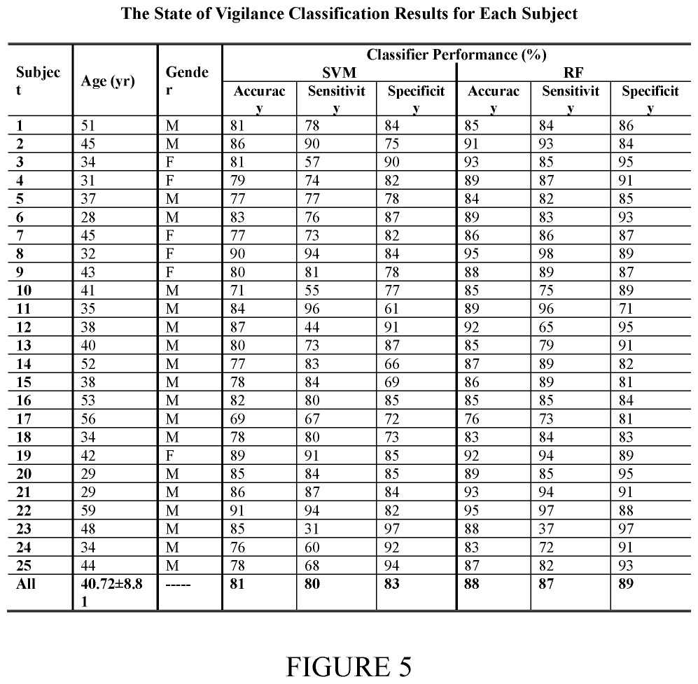

The performance of each classifier was assessed in terms of sensitivity (detection performance for “drowsy” state), specificity (detection performance for “alert” state), and accuracy (performance for both classes together). According to the results shown in FIG. 5, the overall accuracy, sensitivity and specificity of the RF classifier for all 25 subjects together were respectively 88%, 87%, and 89%, while the non-linear SVM revealed an accuracy (sensitivity-specificity) of 81% (80%-83%). As results show, RF outperformed SVM based on all three measures of performance.

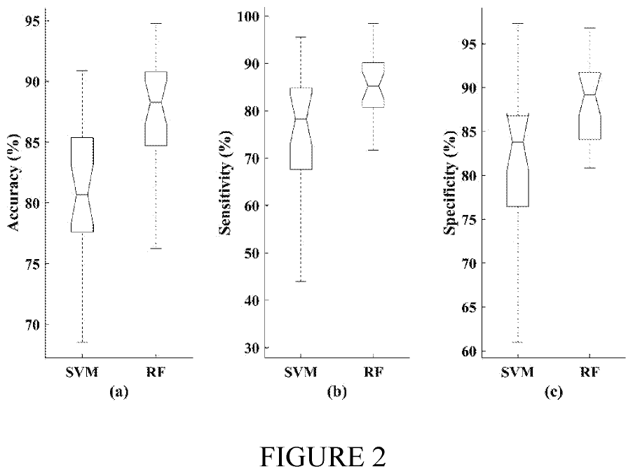

FIG. 5 also presents the classification results for each subject. While the accuracy of the SVM classifier was less than 85% for 17 subjects (and less than 80% for 10 of them), the RF classifier accuracy was greater than or equal to 85% in 21 subjects (i.e., only in 4 subjects, the accuracy was less than 85%, including one with less than 80% accuracy). FIG. 2 compares the distribution of the performance measures for the two classifiers using all subjects, showing noticeable difference between the SVM and RF classifiers. The statistical analyses for comparing the mean and median of the performance measures in two classifiers revealed that the RF classifier significantly outperformed the SVM: accuracy (p<0.001), sensitivity (p<0.05), and specificity (p<0.01).

### Eye Tracking Feature Analysis

In order to better evaluate the performance of the eye tracking features proposed in this work for assessment of the state of vigilance, a novel approach was adopted by combining filter (49) and wrapper (50) feature analysis techniques as follows. Given the training and test datasets resulting from 5-fold cross-validation, the Fisher discriminant ratio ( [symbol] ) was calculated for each feature using the training set as

$${ℱ}_{k} = \frac{{( {μ}_{k}^{drowsy} - {μ}_{k}^{alert} )}^{2}}{{( {σ}_{k}^{drowsy} )}^{2} + {( {σ}_{k}^{alert} )}^{2}} , \qquad ( 7 )$$

where μₖ and σₖ are, respectively, the mean and standard deviation of the kth feature for a particular class of data (i.e., “alert” and “drowsy”). The higher [symbol] is, the more discrimination is observed between the two classes using the kth feature. In the next step, features were sorted based on corresponding [symbol] values in descending order, i.e. a filter method in which a complete independence between the data and classifier was assumed. That is, the most important (discriminative) features was the first feature, and the least important one was the last feature in the list. Given the list of features, then, the performance of each classifier (SVM and RF) was evaluated on the test data by dropping one feature at a time from the bottom of the list (i.e., removing the features with less importance). In this stage, in fact, a wrapper approach in which the classifier performance was part of the feature evaluation was adopted.

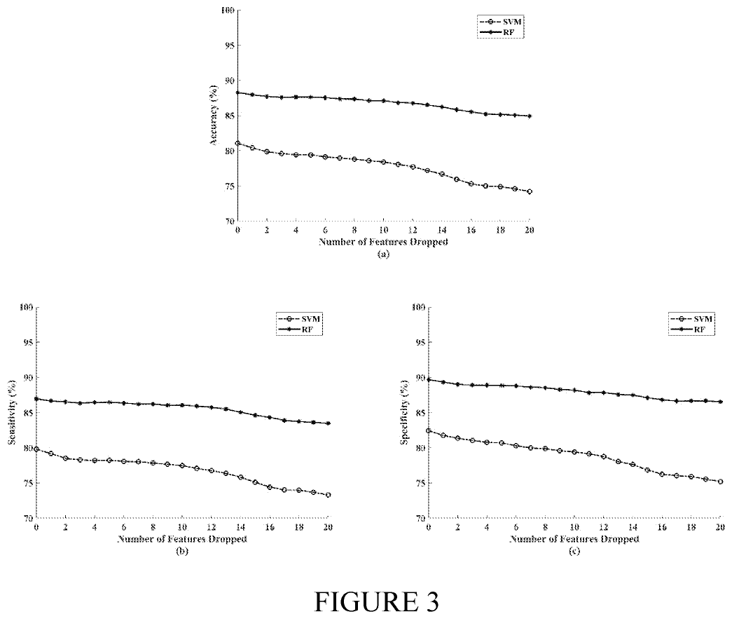

FIG. 3 presents the performance of both classifiers using the proposed feature analysis approach. As expected, by dropping features, the performance decreased for both classifiers. However, the performance drop was more pronounced after removing 13 or 14 features with lower importance (i.e. from the end of the feature list). That is, the performance profile of both classifiers suggested the existence of a quasi-plateau behaviour when the most important features (i.e., top of the list) were kept. Moreover, comparing the performance of the two classifiers reveals that the SVM performance dropped more rapidly than the RF classifier over the course of removing 20 features. While the accuracy of the SVM dropped ˜8.5% over 20 features, the decrease in the RF classifier accuracy was only 3.8%.

### Discussion and Conclusion

In this paper, a machine learning based framework to evaluate the performance of a specific set of 34 eye tracking features (FIG. 4) for assessment of the state of vigilance in drivers is presented. Multimodal data (including eye tracking and EEG recordings) were collected in a simulated driving experiment from 25 volunteers. The experiment was designed to induce mild levels of fatigue/drowsiness in drivers and included two driving sessions for each subject in a random order: a short morning (10 min) driving session, as a control (CD), and a longer mid-afternoon (30 min) driving session (MD). The EEG signal was analyzed to generate binary labels for the eye tracking data (“alert” and “drowsy”). A non-linear SVM (with a Gaussian kernel) and an RF classifier were used separately to assess the state of vigilance, and their performance was compared.

Overall, the results of this study reveal a high level of correspondence between the eye tracking features and EEG as a physiological measure of vigilance. The study verified that the state of vigilance can be classified with high accuracy, sensitivity and specificity using machine learning based classifiers. As reported in FIG. 5, the RF classifier predicted the state of vigilance with more than 80% accuracy in 24 of 25 subjects, where for 18 subjects both sensitivity and specificity were greater than 80%. Moreover, feature analysis using the RF classifier suggested that the excellent performance can be achieved without using all 34 eye tracking features, allowing the development of a drowsiness detection system with less complexity and lower cost. The successful assessment of the drowsiness using short epochs of eye tracking data (i.e., 10 sec.) shows a high time resolution for the proposed approach, which along with the non-intrusive nature of the measurements verifies the potential of this technology to be used for long-term and real-time drowsiness monitoring in drivers.

According to the results, the RF classifier significantly outperformed the non-linear Gaussian SVM. One possible explanation for this performance superiority is that the RF classifier provided a complex model (using 200 trees) which would be more appropriate for the eye tracking data used in this study. It is worth highlighting that the simulated driving experiment in this study was designed in the absence of any sleep deprivation requirement for the participants (as opposed to many previous studies) to induce only a mild level of fatigue. While such a design would reproduce more realistic situations similar to what most drivers may experience in a daily routine, it increases the complexity of the drowsiness detection problem. In fact, the designed experiment reduces the discrimination between the classes of data (i.e., states of vigilance) resulting in a more challenging training phase for the classifiers which can increase the chance of overfitting (i.e., low generalization). The RF classifier combines the votes of a large number of independent decision trees trained on various subsets of the training data to assess a given observation, reducing the risk of overfitting. Also, it is more robust against outliers and noise due to its reliance on the majority vote over all the trees.

This research verifies the potential of the proposed eye tracking features for reliable and unobtrusive long-term assessment of drowsiness in drivers. However, there were some limitations to this study which need to be addressed in the future work. The number of subjects (here 25) is not high enough to represent the general population; therefore, data collection from more subjects is planned. The length of the CD and MD sessions may not be suitable for every subject; longer MD sessions could be necessary to more reliably induce fatigue and drowsiness in various groups of drivers. The duration of each epoch (here 10 sec.) may not be optimal, and hence, more analysis is required.

In this study, the performance of the eye tracking features was evaluated regardless of age, gender and driving experience of the participants. More thorough analyses of these factors and their influence on the performance of drowsiness detection is required. The data used in this work were collected in a laboratory setting, the future studies should consider testing the limits of this technology by adopting more challenging scenarios such using sunglasses and various lighting conditions. Additional experiments will be designed to test the robustness and performance of proposed techniques in real driving scenarios and under various levels of sleep restriction and time of day. This research ultimately will lead to development of an unobtrusive reliable technique for long-term assessment of the state of vigilance, a crucial step towards managing fatigue in drivers and reducing motor vehicle collisions.

### Introduction

Sleep deprivation has reached epidemic proportions in human societies due to life style and work requirements. It is estimated that about 50-70 million Americans suffer from sleep disorders (1), while the average sleep has decreased by about 20 percent over the last century (2). As a consequence, people are more susceptible to fatigue, drowsiness, and/or cognitive deficits, imposing a significant impact on their health, functioning, and safety. In particular, driving performance can be profoundly impaired under the influence of fatigue and drowsiness (3,4), increasing the risk of motor vehicle collisions.

Statistics on motor vehicle accidents in North America highlight the negative effect of drowsy driving on road safety. According to the National Highway Traffic Safety Administration (NHTSA), it is estimated that 7% of all crashes and 16.5% of all fatal collisions involve drowsy driving (5). Moreover, 72,000 police-reported motor vehicle collisions on US roadways in 2015 were related to drowsiness of drivers, causing 41,000 injuries and 800 deaths (5). In Canada, a survey published by the Traffic Injury Research Foundation (TIRF) shows that 18.5% of participants admitted to falling asleep or nodding off at some point behind the wheel (6). TIRF also estimated that 6.4% of all Canadian motor vehicle fatalities in 2013 involve drowsy drivers (6).

Therefore, development of early warning systems for monitoring of the state of vigilance in drivers is critical in order to reduce the risk of motor vehicle accidents. Such a technology can be used as a countermeasure for managing fatigue and drowsiness in drivers to improve road safety. Despite various attempts in the past, development of a reliable non-intrusive technique for early detection of drowsy driving has remained challenging.

### Background

Overall, the influence of fatigue and drowsiness in drivers can be objectively measured using physiological responses (7-13), driver behavioural patterns (14-21), and/or driving performance (4,16,22-24), among which physiological responses, such as electroencephalogram (EEG), electrocardiogram (ECG) or electro-oculagram (EOG) produce more reliable measures with very high temporal resolution necessary to detect subtle changes in vigilance well in advance of behavioural lapses. However, due to their intrusive nature, the application of techniques based on such measures are limited for long-term driver monitoring in real-world conditions. In a recent study (13), EEG features from multiple independent brain sources were integrated, where the reaction time was used a baseline for vigilance. An average classification accuracy of 88% was reported using this approach. Shuyan and Gangtie (11) employed a support vector machine (SVM) for drowsiness detection in 37 sleep-deprived drivers using eyelid features extracted from EOG and assessed the performance based on subjective reports. Khushaba et al. proposed a wavelet-based technique to extract features from EEG, EOG and ECG to detect drowsiness (10). These features were tested in combination with different classifiers such as SVM, linear discriminant analysis and k-nearest neighbours, resulting in 95%-97% accuracy across all subjects.

Measures relying on driver behavioural patterns, (such as eye movements and facial expressions) are non-intrusive and more applicable for long-term monitoring of drowsiness, although their accuracy and time resolution would not be as high as measures based on physiological responses. Percentage of eyelid closure (PERCLOS) is one of the behavioural patterns used in several studies in the past. PERCLOS is defined as the percentage of time that eyes are closed more than a minimum level, e.g. at least 80% closed (20,25). Jackson et al. (15) studied the influence of sleep loss on PERCLOS, in a simulated driving task, observing that sleep deprivation significantly increased PERCLOS. Some studies, however, reported a noticeably lower accuracy for PERCLOS, compared to techniques based on biological signals (26). A major limitation of PERCLOS is its dependency on the length of the time window used to compute the measure. Large time intervals would be required to provide good prediction (27), resulting in a noticeable delay for drowsiness detection (19). Moreover, subject blinking patterns affect PERCLOS performance (27) and the method can fail in case of drivers falling asleep with eyes open (19). In some studies, PERCLOS has been used along with other measures. Bergasa et al. (19) observed that the delay between the moment that system detected the drowsiness and the actual onset of drowsiness increased if only PERCLOS was used, while the fixed gaze features reduced the detection latency. Some other studies (17,28) used facial features such as yawning to detect fatigue.

Driving performance indicators, such as standard deviation of lateral position, have also been used to assess drowsiness in drivers. While this type of information can be collected non-intrusively using vehicle embedded sensors, the accuracy of methods relying on these measures can be affected by several factors such as road/weather conditions, driver experience level and even vehicle model. In (23), using various combinations of acceleration (lateral and longitudinal) and steering wheel angle in a driving simulator study, an accuracy of ˜85% for detection of drowsiness using a random forest (RF) classifier was achieved. In a recent study (16), several driving performance measures along with eye tracking information were used to estimate the drowsiness level. An artificial neural network and a logistic model were used for classification, resulting in 88% and 83% accuracy respectively.

### Objectives

Despite development of various methodologies in the past for driver drowsiness detection, the available technologies generally do not meet all requirements that make them reliable and appropriate for real-time monitoring of driver status. In particular, many of the proposed solutions suffer from a long detection delay, reducing the effectiveness of these techniques to prevent motor vehicle collisions. Moreover, while some of these technologies are not appropriate for vehicle environment because of high sensitivity to weather, lightening and/or road conditions, some others are intrusive, and therefore, cannot be used for long-term monitoring. Another limitation of some proposed technologies is that their performance has not been appropriately evaluated against reliable baselines (such as physiological measures of vigilance).

The goal of this study is to evaluate the performance of eye tracking data as a non-intrusive measure of driver behaviour for reliable and real-time monitoring of the state of vigilance in drivers. Ultimately, this would lead to development of an “early warning” technology which can be used as an effective countermeasure for driving impairment due to fatigue and drowsiness and improve road safety. In two previous studies (29,30), the authors reported the performance of some characteristics of eye movements and blinking for drowsiness assessment using a well-characterized prolonged psychomotor vigilance task (PVT). The results showed a high correspondence between the eye tracking data and the reaction time to visual stimuli (as an objective measure of vigilance). In a recent preliminary study (31), we evaluated the performance of a specific set of thirty-four eye tracking features for drowsiness detection against an EEG baseline, using data acquired from 25 subjects. In this work, we expand the assessment of these eye tracking features by using a larger group of volunteers and adopting various lengths of the time window (i.e. epoch) from which the features are extracted. This paper evaluates and compares the performance of two machine learning techniques for binary classification of the state of vigilance (“alert” vs. “drowsy”). The EEG data, simultaneously recorded with eye tracking data, was used as the baseline in this study. In Materials and Methods, the paper describes the driving simulator experiment and methodologies used to collect and process the multimodal data, extract features and classify the observations. Then, results of the study are presented in Experimental Results section, and the paper is finally concluded by Discussion and Conclusion section, providing some discussions and directions for future work.

### Materials and Methods

In this section, details of the driving simulator experiment are provided. The section also elaborates on the eye tracking feature extraction, classifiers used for drowsiness detection, and analysis of EEG data (i.e., the baseline).

### Driving Simulator Experiment

This experiment was conducted at the Somnolence Laboratory of Alcohol Countermeasure Systems Corp. (AC S), Toronto, Canada. Inducing mild levels of drowsiness and fatigue in participating drivers, the designed experiment provided the opportunity to study changes in the state of vigilance measured by visual behavioural patterns and physiological responses.

### Subjects

In this study, 53 volunteers (16 females, 37 males) with the age of 38.1±11.6 years (mean±SD¹) participated in the driving simulator sessions, following a written consent. All subjects were given a written summary, describing the objectives, procedures, and potential risks of the study as well as their rights and privacy. Each participant attended a trial session at the beginning of the experiment in order to get familiar with the procedure and operation of the driving simulator. The subjects were allowed to wear glasses and/or contact lenses as they would do for normal driving. ¹ standard deviation

### Multimodal Data Collection

The experiment was conducted using the SimuRide PE-3 driving simulator with three 22″ high-definition monitors, providing a wide angle of view.

The SmartEye Pro 6.0 eye tracking system with two infrared cameras was mounted on the driving simulator to capture eye gaze, eye position, eyelid, blinking and pupilometry data of drivers, with the sampling rate of 60 Hz. The system was calibrated at the beginning of each driving session and delivered fixation and saccade labels for the eye gaze, measured at the accuracy of 0.5 degrees. The EEG was also recorded simultaneously with the eye tracking data using the Emotiv EPOC+headset with 14 channels at the sampling frequency of 128 Hz.

### Procedure

Subjects were asked to participate in two counterbalanced driving sessions held on different days in a random order: one control (CD) session and one monotonous (MD) driving session. Both sessions included driving on a low-traffic highway. The CD session was 10-min long and held in late morning (around 10 am) when the participant was highly alert. Participants were allowed to engage in conversation with the experimenter without any restrictions on the speed and driving style, such as changing lanes or taking a turn using bridges, in order to reduce the chance of fatigue and boredom. On the other hand, the MD session was designed to induce mild levels of fatigue and drowsiness. Subjects were required to drive for a noticeably longer period of time (i.e., 30 minutes) under monotonous driving conditions on a low-traffic highway in the MD session. Also, the driver was not allowed to communicate with the experimenter and needed to comply with the speed limit of 120 km/h (˜75 mph) and follow specific traffic rules (e.g. pulling over, taking turns and unnecessary changing lanes were not permitted). In order to increase the chance of drowsiness and fatigue, the MD session was conducted at the mid-afternoon dip of the alertness circadian cycle (32) after lunch (around 2 pm). All participants refrained from drinking coffee and tea for at least two hours before the MD session. It is worth highlighting that the subjects were not put under any forms of sleep deprivation in this study.

### Eye Tracking Feature Extraction

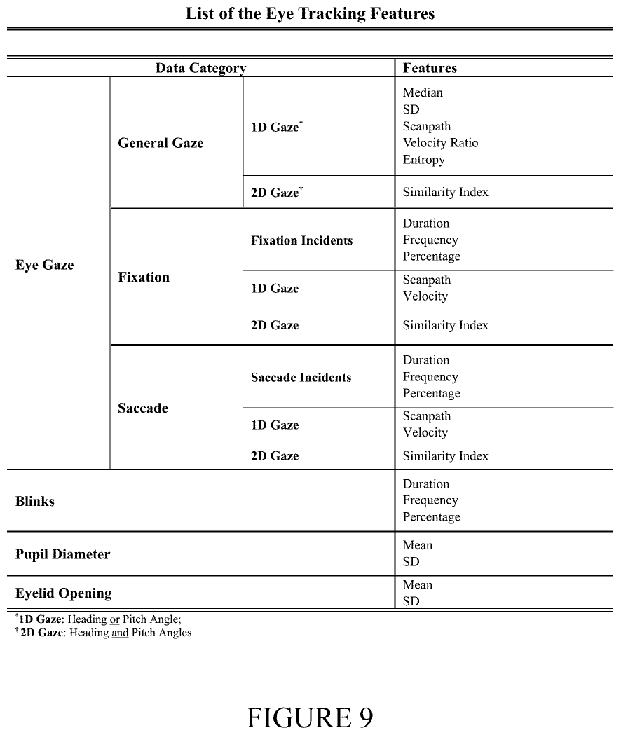

After recording the multidimensional eye tracking data, the recordings were segmented into (time) epochs with 50% overlap, and 34 distinct features were extracted from each epoch. FIG. 9 presents the full list of the features, extracted from eye gaze, blinks, pupil diameter, and eyelid opening data. The eye gaze consisted of a two dimensional angular vector: heading (left/right) and pitch (up/down) angles in radian. For feature extraction, the eye gaze data were divided into general gaze, fixation, and saccade. In this study, to investigate the influence of the epoch length on drowsiness detection performance, epochs with various lengths were considered for feature extraction: 5, 10, 15, 20, 25, 30, 40, 50 and 60 seconds. Details of the extracted features are provided in the following.

### Mean, Median, and SD

Given a specific epoch of the eye tracking data, these statistics were computed for some eye measurements, e.g. gaze pitch angle or eyelid opening distance, over the entire epoch.

### Duration, Frequency, and Percentage

These features were calculated for specific eye movements and patterns: fixations, saccades and blinks. Let [symbol] be the time length of the kth incident of an eye movement/pattern, where k=1, 2, . . . , M (M is the total number of the incidents), in a given epoch with the time length of L. Then, the duration feature is defined as

$$D = \frac{1}{M} {\sum }_{k = 1}^{M} {𝓁}_{k} \qquad ( 1 )$$

The frequency feature is simply defined as ratio of the total number of incidents of the eye movement/pattern to the length of epoch, i.e. M/L. The percentage feature measures the fraction of the epoch including the desired eye movement/pattern:

$$P = \frac{1}{L} {\sum }_{k = 1}^{M} {𝓁}_{k} . \qquad ( 2 )$$

### Scanpath

This feature was calculated based on gaze values in a given epoch and is defined as total movement of eye in a specific dimension. For a set of gaze values {gᵢ^{d}}_{i=1:N}, the scanpath is calculated as

$${λ}^{d} = {\sum }_{i = 2}^{N} \vert {g}_{i ,}^{d} - {g}_{i - 1}^{d} \vert , \qquad ( 3 )$$

where |.| is the absolute value operator, i is the gaze sample number in chronological order, N is the total number of gaze samples, and d is the dimension of gaze (pitch or heading) for which the scanpath is computed.

### Velocity and Velocity Ratio

In case of fixation and saccade data, the average velocity over all incidents of the eye movement (fixation or saccade) in the given epoch was computed for each dimension (heading and pitch) as the velocity feature.

For the general gaze data, however, due to the large variability of the raw velocity, a velocity ratio feature was defined for each dimension in every epoch as

$${ϑ}^{d} = ln ( \frac{{v}_{max}^{d}}{{v}_{median}^{d}} ) , \qquad ( 4 )$$

where ln(.) is the natural logarithm operator, and vₘₐₓ^{d} and V_{median}^{d} are the peak and median velocities for dimension d of the gaze data respectively.

### Entropy

For each dimension of general gaze data, the differential entropy (33) was computed in each epoch as

$${η}^{d} = - {{\int }_{- ∞}}^{ ∞} \hat{p} ( {g}^{d} ) ln \hat{p } ( {g}^{d} ) , \qquad ( 5 )$$

in which \hat{p}(g^{d}) is the estimated probability density function of the gaze data in dimension d, calculated by kernel techniques (34).

### Similarity Index

For each epoch of the eye gaze data, a similarity index was calculated based on correlation sum measure (35) to assess how concentrated the gaze was during that epoch. Given the set of gaze vectors {gᵢ}_{i=1:N} in the current epoch, where gᵢ=[gᵢ^{h} gᵢ^{p}]^{T} is the ith gaze vector (gᵢ^{h} and gᵢ^{p} are respectively the gaze heading and pitch angles) and N is the total number of gaze vectors, the similarity index is defined as

$$𝒮 = \frac{2}{N ( N - 1 )} {\sum }_{i = 1}^{N - 1} {\sum }_{j = i + 1}^{N} ℍ ( ɛ - ‖ {g}_{i} - {g}_{j} ‖ ) , \qquad ( 6 )$$

where [symbol] (.) is the Heaviside step function, ∥.∥ is the Euclidean distance, and ε is the neighborhood radius, set to 0.087 radian (5 deg.) in this work.

### Classification

In this study, a non-linear SVM and an RF classifier have been used for binary identification of the state of vigilance, i.e. “alert” and “drowsy”, based on features extracted from the eye tracking data.

### Support Vector Machine (SVM)

SVMs minimize the classification error by maximizing the margin between the closest observations from each class (i.e. support vectors) and the decision boundary (36,37). In case of binary classification using non-linear SVMs, the decision boundary can be presented as a hyperplane Λ^{T}φ(x)+τ=0 in a higher-dimensional space, where Λ is the normal to the hyperplane, τ is a scalar constant, and φ(x) maps the feature vector x into the higher-dimensional space. To find the decision boundary, however, the mapping function φ(x) does not need to be known. That is, by choosing a proper kernel function defined as K(xᵢ,xⱼ)=φ(xᵢ)^{T}φ(xⱼ), the optimization problem can be solved in the original feature space. In this study, a Gaussian kernel function was adopted for the non-linear SVM classifier.

### Random Forest (RF)

RFs are ensemble learning methods (38) for regression, classification or other prediction tasks. An RF classifier is a set of N tree-structured classifiers {h(x,Φₙ), n=1, . . . , N}, where {Φₙ} are independent and identically distributed random vectors. In this ensemble, each member (i.e., tree classifier) casts a vote for the most popular class at input x (39). Generally, the RF algorithm uses N bootstrap replicates of data to train the N different decision trees (in this work, 200). To predict the class of a given data point (i.e., test data point), the majority vote over all the classifiers (trees) is taken.

Individual decision trees may overfit to the training data. Since the RF classifier combines the results of many decision trees, the influence of overfitting is reduced (i.e., decreasing the variance of the model, without increasing the bias) which improves generalization. The accuracy of RF classifiers is better than decision trees, as good as Adaboost (40) and sometimes even better. Given the fact that the predictions are based on the average of many trees, it is relatively more robust to outliers and noise than a single tree. Moreover, RFs provide useful internal estimates of variable importance. Since the training of each tree does not affect the others, the algorithm is simple and can be easily parallelized.

### EEG Signal Processing

In this study, characteristic changes in the EEG power spectrum were analyzed in order to assess the level of drowsiness, e.g. see (7,41,42), and generate corresponding binary labels (i.e., “alert” vs. “drowsy”) for each epoch of the eye tracking data. EEG waveforms in four distinct frequency bands were analyzed (43): the δ-band (0.5-4 Hz), the θ-band (4-7 Hz), the α-band (8-12 Hz), the β-band (13-30 Hz). A 60-Hz notch filter was first applied to the multichannel EEG signal, and the signal was band-passed filtered between 0.2 and 45 Hz. Seven bipolar EEG channels (AF₃-AF₄, F₇-F₈, F₃-F₄, FC₅-FC₆, T₇-T₈,P₇-P₈,O₁-O₂) were then used for power spectral analysis.

In this work, the short-time Fourier transform was applied to EEG channels and the β/α and α/(δ+θ) power ratios were computed for each EEG epoch in every channel. The changes in these statistics were then monitored. The higher the spectral power ratios are, the higher the level of the alertness. Using the EEG data from the first 5 minutes of CD session for each subject as the reference, a binary subject-specific measure of vigilance were computed for each epoch: “alert” (EEG power ratios equal to or greater than the reference) and “drowsy” (EEG power ratios less than the reference).

### Experimental Results

This section presents the results of the proposed machine learning approach for binary classification of the state of vigilance based on eye tracking features. As summarized in FIG. 1, after extracting the 34-dimensional feature vector from each epoch of eye tracking data, the true label (alert/drowsy) for that epoch was determined using the simultaneously recorded EEG data. Then, the eye tracking feature vectors and their corresponding labels from all subjects in both sessions (CD and MD) were added together and used to assess the performance of the proposed methodology using a 5-fold cross-validation approach.

### Classification Results Using Various Epoch Lengths

The performance of each classifier was assessed using different lengths of epoch, used to extract eye tracking features (5, 10, 15, 20, 25, 30, 40, 50 and 60 seconds). Three performance measures were calculated: sensitivity (detection performance for “drowsy” state), specificity (detection performance for “alert” state), and accuracy (performance for both classes together).

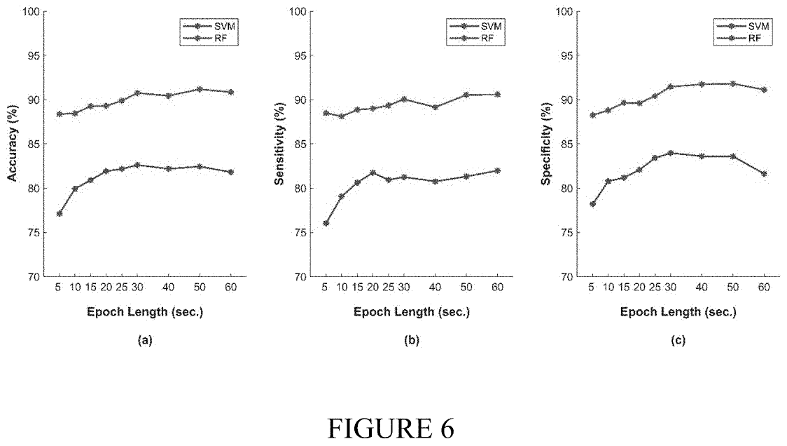

FIG. 6 compares the overall performance of the two classifiers across different epoch lengths. As shown, the performance of both classifiers noticeably improves by increasing the epoch length initially; however, it either drops or remains approximately unchanged for epochs longer than 30 sec. A possible explanation for this observation would be as follows. By increasing the length of epochs, more information is captured through the extracted features; therefore, the classifier performance improves in general. However, at some point, the length of epoch is such long that extracted features will be insensitive to short but important changes of eye tracking data (i.e., non-stationary data), leading to less informative features and lower classifier performance. It is also worth highlighting that longer epochs will increase the delay of detecting a noticeable change in the state vigilance (in real-time processing).

According to the results, the RF classifier outperforms the non-linear SVM on all measures of performance and shows less variation in the performance (i.e., higher robustness against the epoch length). The observed mean±SD of accuracy (sensitivity-specificity) for RF and SVM classifiers across all epoch lengths was, respectively, 89.84±1.05% (89.35±0.87%-90.32±1.31%) and 81.24±1.76% (80.42±1.84%-82.06±1.86%).

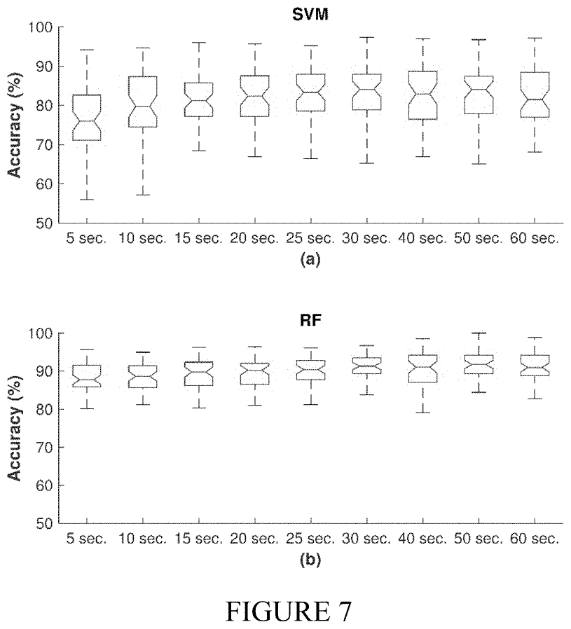

FIG. 7 presents the distribution of the accuracy measure for the two classifiers across all 53 subjects using different lengths of epoch. A two-way ANOVA test revealed a significant effect of the epoch length on the classification accuracy (F_{8,936}=4.846, p<0.001) as well as a strong significant difference between the accuracy of the two classifiers (F_{1,936}=440.06, p<0.0001), while no evidence of interaction between the classifier type and the epoch length was observed (F_{8,936}=0.818, p=0.59).

### Eye Tracking Feature Analysis

In order to better evaluate the performance of the eye tracking features proposed in this work for assessment of the state of vigilance, a novel approach was adopted by combining filter (44) and wrapper (45) feature analysis techniques as follows. Given the separate training and test datasets (here, using a 5-fold cross-validation), the Fisher discriminant ratio ( [symbol] ) is calculated (using the training set) for each feature as

$${ℱ}_{k} = \frac{{( {μ}_{k}^{drowsy} - {μ}_{k}^{alert} )}^{2}}{{( {σ}_{k}^{drowsy} )}^{2} + {( {σ}_{k}^{alert} )}^{2}} , \qquad ( 7 )$$

where μₖ and σₖ are, respectively, the mean and standard deviation of the kth feature for a particular class of data (i.e., “alert” and “drowsy”). The higher [symbol] is, the more discrimination is observed between the two classes using the kth feature. Features are sorted based on corresponding [symbol] values in descending order, i.e. a filter method in which a complete independence between the data and classifier was assumed. That is, the most important (discriminative) feature is at the top of the list and the least discriminative one is at the bottom. Given the list of features, then, the performance of the classifier is evaluated on the test data by dropping one feature at a time from the bottom of the list (i.e., a wrapper approach). Here, the whole process (including the cross-validation) was repeated 3 times for each classifier.

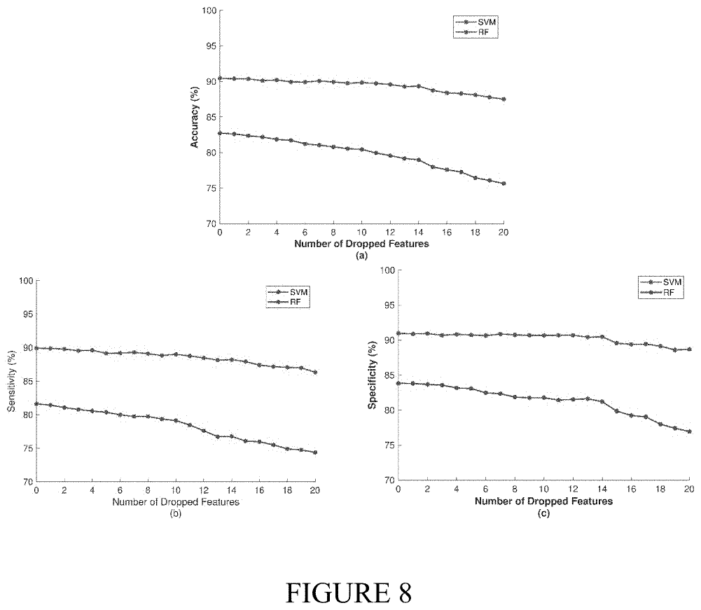

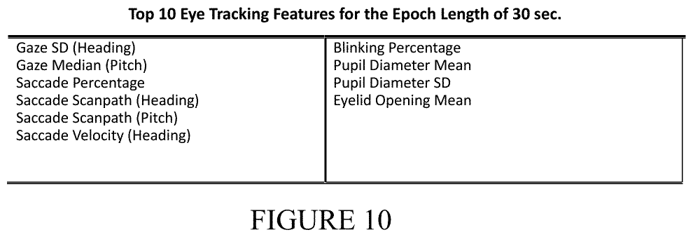

Given the results of classification using different lengths of epoch from which eye tracking features were extracted, the epoch length of 30 sec. was adopted for feature analysis. FIG. 8 presents the performance of both classifiers, while dropping features. As shown, the performance decreased for both classifiers by reducing the number of features. However, the performance drop was more pronounced after removing 13 or 14 features with less importance. Comparing the performance of the two classifiers reveals that the SVM performance dropped more rapidly than the RF classifier over the course of removing 20 features. While the accuracy of the SVM dropped ˜8.55% over 20 features, the decrease in the RF classifier accuracy was only 3.24%. FIG. 10 lists ten features that have been always among the top 20 features in every trial, i.e. cross-validation/repetition (based on [symbol] values).

### Discussion and Conclusion

In this paper, a machine learning framework for non-intrusive drowsy driving detection using a specific set of 34 eye tracking features (FIG. 9) was presented. Eye tracking and EEG data were collected from 53 volunteers, participating in a simulated driving experiment. The experiment was designed to induce mild levels of fatigue/drowsiness in drivers and included two driving sessions for each subject in a random order: a short morning driving session (10 min), as a control (CD), and a longer mid-afternoon (30 min) driving session (MD). The eye tracking features were extracted from overlapping epochs, and two classifiers (a non-linear SVM with a Gaussian kernel and an RF classifier with 200 trees) were used separately to assess the state of vigilance. The simultaneously recorded EEG signal, as a physiological measure of vigilance (baseline), was processed to label the eye tracking epochs as “alert” or “drowsy”. To explore the influence of the epoch length on the performance of drowsy driving detection, various lengths of epoch were selected, and the results were compared. Moreover, the relevance (importance) of the proposed eye tracking features was assessed using a feature analysis approach.

The results of this study confirmed that drowsy driving can be reliably detected with high accuracy, sensitivity and specificity using eye tracking data and appropriate classification framework. As presented in FIG. 6, the overall accuracy of the RF classifier ranged from 88.37% to 91.18% for different lengths of epoch. Furthermore, the RF classifier predicted the state of vigilance with more than 80% accuracy in 51 subjects, for all different lengths of epoch. In addition, for any given epoch length, the accuracy of the RF classifier was higher than 85% in more than 77% of subjects. According to feature analysis results for epoch length of 30 sec., the RF classifier performance presented a quasi-plateau behaviour when the most important features were kept. FIG. 10 shows that the top 10 features were related to all categories of eye tracking data, except fixations. Based on the reported performance for the two classifiers, shorter eye tracking epochs can also be used to achieve acceptable drowsiness detection results. For instance, using 10-sec epochs, RF and SVM classifiers respectively revealed an accuracy (sensitivity-specificity) of 88.5% (88.1%-88.8%) and 79.9% (79.1%-80.8%). The possibility of adoption of short epoch lengths (i.e., higher time resolution and lower detection delay) for the proposed approach, along with the non-intrusive nature of the measurements, verifies the potential of this technology to be used for long-term and real-time drowsiness monitoring in drivers. Moreover, feature analysis using the RF classifier also suggested that an acceptable performance can be achieved without using all 34 eye tracking features, allowing the development of a drowsiness detection system with less complexity and lower cost.

According to the results, the RF classifier outperformed the non-linear SVM. One possible explanation for this performance superiority is that the RF classifier provides a complex model which would be more appropriate for the eye tracking data used in this study. It is worth highlighting that the simulated driving experiment was conducted in the absence of any sleep deprivation (as opposed to many previous studies) and induced only a mild level of fatigue. While such a design would create more realistic situations, similar to what most drivers may experience in a daily routine, it increases the complexity of the drowsiness detection problem. In fact, the designed experiment reduces the discrimination between the classes of data (i.e., states of vigilance) resulting in a more challenging training phase for the classifiers which can increase the chance of overfitting (i.e., low generalization). The RF classifier combines the votes of a large number of independent decision trees trained on various subsets of the training data to assess a given observation, reducing the risk of overfitting. Also, it is more robust against outliers and noise due to its reliance on the majority vote over all the trees.

This research verifies the potential of the proposed eye tracking features for reliable and unobtrusive long-term assessment of drowsiness in drivers. However, there were some limitations to this study which need to be addressed as part of the future work. The length of the CD and MD sessions may not be suitable for every subject; longer MD sessions would be necessary to more reliably induce fatigue and drowsiness in various groups of drivers. The number of subjects (here 53) is not large enough to model the general population; therefore, data collection from more subjects is planned. The effect of gender, age and driving experience has not been studied. More analyses are required to assess the influence of these factors. This was a laboratory study; the study needs to be expanded to test the robustness and performance of this drowsiness detection technology in real driving conditions. Various lighting situations as well as different levels of sleep restriction and time of day need to be considered. Ultimately, this research will lead to development of a non-intrusive reliable “early warning” technology for long-term monitoring of the state of vigilance, a critical step towards preventing drowsy driving and reducing motor vehicle collisions.

### Author Contribution Statement

The authors confirm contribution to the paper as follows. Study conception and design: A. S. Zandi, A. Quddus, F. J. E. Comeau; data collection: A. S. Zandi, L. Prest; analysis and interpretation of results: A. S. Zandi; draft manuscript preparation: A. S. Zandi, A. Quddus, L. Prest , F. J. E. Comeau. All authors reviewed the results and approved the final version of the manuscript.

### Acknowledgements

We are thankful to Ms. Min Liang at Department of Electrical and Computer Engineering, McGill University, Montreal, Canada, for taking part in preliminary data analysis.

### REFERENCES

1. NCSDR (National Commission on Sleep Disorders Research). Wake Up America: A National Sleep Alert. Volume II: Working Group Reports. Washington, D.C.; 1994.
2. Tjepkema, M. Insomnia. Health Rep. Vol. 17, 2005, pp. 9-25.
3. Philip, P., P. Sagaspe, J. Taillard, N. Moore, C. Guilleminault, M. Sanchez-Ortuno, et al. Fatigue, Sleep Restriction, and Performance in Automobile Drivers: A Controlled Study in a Natural Environment. Sleep. Vol. 26, 2003, pp. 277-280.
4. Perrier, J., S. Jongen, E. Vuurman, M. L. Bocca, J. G. Ramaekers, A. Vermeeren. Driving Performance and EEG Fluctuations During On-the-Road Driving Following Sleep Deprivation. Biological Psychology. Vol. 121, 2016, pp. 1-11.
5. NHTSA. Asleep at the Wheel: A National Compendium of Efforts to Eliminate Drowsy Driving. National Highway Traffic Safety Administration (NHTSA), U.S. Department of Transportation; 2017, pp. 1-24.
6. TIRF (Traffic Injury Research Foundation). Fatigure-Related Fatal Collisions in Canada. Ottawa; 2016.
7. Jap, B. T., S. Lal, P. Fischer, E. Bekiaris. Using EEG Spectral Components to Assess Algorithms for Detecting Fatigue. Expert Systems with Applications. Vol. 36, 2009, pp. 2352-2359.
8. Sun, H., B. Lu. EEG-Based Fatigue Classification by Using Parallel Hidden Markov Model and Pattern Classifier Combination. In The 19th International Conference on Neural Information Processing—Volume Part IV. Berlin, Heidelberg: Springer-Verlag; 2012, pp. 484-491.
9. Eoh, H. J., M. K. Chung, S. H. Kim. Electroencephalographic Study of Drowsiness in Simulated Driving with Sleep Deprivation. International Journal of Industrial Ergonomics. Vol. 35, 2005, pp. 307-320.
10. Khushaba, R. N., S. Kodagoda, S. Lal, G. Dissanayake. Driver Drowsiness Classification Using Fuzzy Wavelet-Packet-Based Feature Extraction Algorithm. IEEE Trans on Biomedical Enginnering. Vol. 58, 2011, pp. 121-131.
11. Shuyan, H., Z. Gangtie. Driver Drowsiness Detection with Eyelid Related Parameters by Support Vector Machine. Expert Systems with Applications. Vol. 36, 2009, pp. 7651-7658.
12. Yang, G., Y. Lin, P. Bhattacharya. A Driver Fatigue Recognition Model Based on Information Fusion and Dynamic Bayesian Network. Information Sciences. Vol. 180, 2010, pp. 1942-1954.
13. Chuang, C-H., C-S. Huang, L-W Ko, C-T Lin. An EEG-Based Perceptual Function Integration Network for Application to Drowsy Driving. Knowledge-Based Systems. Vol. 80, 2015, pp. 143-152.
14. Jackson M. L., G. A. Kennedy, C. Clarke, M. Gullo, P. Swann, L. A. Downey, et al. The Utility of Automated Measures of Ocular Metrics for Detecting Driver Drowsiness During Extended Wakefulness. Accident Analysis & Prevention. Vol. 87, 2016, pp. 127-133.
15. Jackson M. L., S. Raj, R. J. Croft, A. C. Hayley, L. A. Downey, G. A. Kennedy, et al. Slow Eyelid Closure as a Measure of Driver Drowsiness and Its Relationship to Performance. Traffic Injury Prevention. Vol. 17, 2016, pp. 251-257.
16. Wang X., C. Xu. Driver Drowsiness Detection Based on Non-Intrusive Metrics Considering Individual Specifics. Accident Analysis and Prevention. Vol. 95, 2016, pp. 350-357.
17. Azim T., M. A. Jaffar, A. M. Mirza. Fully Automated Real Time Fatigue Detection of Drivers Through Fuzzy Expert Systems. Applied Soft Computing. Vol. 18, 2014, pp. 25-38.
18. Garcia I., S. Bronte, L. M. Bergasa, J. Almazan, J. Yebes. Vision-Based Drowsiness Detector for Real Driving Conditions. In IEEE Intelligent Vehicles Symposium, Proceedings. 2012, pp. 618-623.
19. Bergasa L. M., J. Nuevo, M. A. Sotelo, R. Barea R, M. E. Lopez. Real-Time System for Monitoring Driver Vigilance. IEEE Transactions on Intelligent Transportation Systems. Vol. 7, 2006, pp. 63-77.
20. Dinges D. F., M. M. Mallis, G. Mailslim, J. W. Powell. Evaluation of Techniques for Ocular Measurement as an Index of Fatigue and the Basis for Alertness Management. Washington, D.C.: U.S. Dept. Transp., NHTSA; 1998.
21. Wang Y., M. Xin, H. Bai, Y. Zhao. Can Variations in Visual Behavior Measures Be Good Predictors of Driver Sleepiness? A real Driving Test Study. Traffic Injury Prevention. Vol. 18, 2017, pp. 132-138.
22. Wierwille W., W. Wreggit, C. Kirn, A. Ellsworth, R. Fairbanks. Research on Vehicle-Based Driver Status/Performance Monitoring: Development, Validation, and Refinement of Algorithms for Detection of Driver Drowsiness. Washington, D.C.: U.S. Dept. Transp., NHTSA Final Report: DOT HS 808 247; 1994.
23. Krajewski J., D. Sommer, U. Trutschel, D. Edwards, M. Golz. Steering Wheel Behavior Based Estimation of Fatigue. In Proceedings of the Fifth International Driving Symposium on Human Factors in Driver Assessment, Training and Vehicle Design. 2009, pp. 118-124.
24. Wang M. S., N. T. Jeong, S. B. KIM, S. M. Yang, S. You, J. H. Lee, et al. Drowsy Behaviour Detection Based on Driving Information. International Journal of Automotive Technology. Vol. 17, 2016, pp. 165-173.
25. Zhang H., C. Wu, Z. Huang, X. Yan, T. Z. Qiu. Sensitivity of Lane Position and Steering Angle Measurements to Driver Fatigue. Transportation Research Record: Journal of the Transportation Research Board. No. 2585, 2016, pp. 67-76.
26. Dinges D. F., R. Grace. PERCLOS: A valid Psychophysiological Measure of Alertness as Assessed by Psychomotor Vigilance. Washington, D.C.,: Fed. Highway Admin., Office Motor Carriers, 1998.
27. Sommer D., M. Golz. Evaluation of PERCLOS Based Current Fatigue Monitoring Technologies. In 32nd EMBS Conference. 2010, pp. 4456-4459.
28. Dong Y., Z. Hu, K. Uchimura, N. Murayama. Driver Inattention Monitoring System for Intelligent Vehicles: A Review. IEEE Transactions on Intelligent Transportation Systems. Vol. 12, 2011, pp. 596-614.
29. Fan X., Y. Sun, B. Yin, X. Guo. Gabor-Based Dynamic Representation for Human Fatigue Monitoring in Facial Image Sequences. Pattern Recognition Letters. Vol. 31, 2010, pp. 234-243.
30. Shahidi Zandi A., A. Quddus, F. Comeau, S. Fogel. A Novel Non-Intrusive Approach to Assess Drowsiness Based on Eye Movements and Blinking. In 10th International Conference on Managing Fatigue. San Diego, Calif., 2017. p. 1-3.
31. Shahidi Zandi A., A. Quddus, F. Comeau, S. Fogel. Non-Intrusive Monitoring of Drowsiness Using Eye Movement and Blinking. In 27th CARSP Conference. Toronto, Ontario; 2017. p. 1-16.
32. Akerstedt T., M. Gillberg. Subjective and Objective Sleepiness in the Active Individual. International Journal of Neuroscience. Vol. 52, 1990, pp. 29-37.
33. Kaida K., M. Takahashi, T. Akerstedt, A. Nakata, Y. Otsuka, T. Haratani, et al. Validation of the Karolinska Sleepiness Scale Against Performance and EEG Variables. Clinical Neurophysiology. Vol. 117, 2006, pp. 1574-1581.
34. Drummond S. P., A. Bischoff-Grethe, D. F. Dinges, L. Ayalon, S. C. Mednick, M. J. Meloy. The Neural Basis of the Psychomotor Vigilance Task. Sleep. Vol. 28, 2005, pp. 1059-1068.
35. Belenky G., N. J. Wesensten, D. R. Thorne, M. L. Thomas, H. C. Sing, D. P. Redmond, et al. Patterns of Performance Degradation and Restoration During Sleep Restriction and Subsequent Recovery: A sleep Dose-Response Study. Journal of Sleep Research. Vol. 12, 2003, pp. 1-12.
36. Basner M. , D. F. Dinges. Maximizing Sensitivty of the PVT to Sleep Loss. Sleep. Vol. 34, 2011, pp. 581-591.
37. Goel N., H. P. A. Van-Dongen, D. F. Dinges. Circadian Rhythms in Sleepiness, Alertness, and Performance. In Principles and Practice of Sleep Medicine (M. H. Kryger, T. Roth, W. C. Dement, ed.). Saunders: Elsevier; 2011. pp. 445-455.
38. Lazo A., P. Rathie. On the Entropy of Continous Probability Distributions. IEEE TRansactions on Information Theory. Vol. 24, 1978, pp. 120-122.
39. Parzen E., T. Annals, N. Sep. On Estimation of a Probability Density Function and Mode. Vol. 33, 2008, pp. 1065-1076.
40. Kantz H., T. Schreiber. Nonlinear Time Series Analysis. Cambridge University Press, Cambridge, 2004.
41. Burges C. A Tutorial on Support Vector Machines for Pattern Recognition. Data Mining and Knowledge Discovery. Vol. 2, 1998, pp. 121-167.
42. Campbell C. Algorithmic Approaches to Training Support Vector Machines: A Survey. In 8th European Symposium on Artificial Neural Networks. Bruges, Belgium; 2000, pp. 27-36.
43. Opitz D., R. Maclin. Popular Ensemble Methods: An Empirical Study. Journal of Artificial Intelligence Research. Vol. 11, 1999, pp. 169-198.
44. Breiman L. Random Forests. Machine Learning. Vol. 45, 2001, pp. 5-32.
45. Schapire R. E. A Brief Introduction to Boosting. In Proceedings of 16th International Joint Conference on Artificial Intelligence. 1999, pp. 1401-1406.
46. Bonnet M. H. Acute Sleep Deprivation. In Principles and Practice of Sleep Medicine (M. H. Kryger, T. Roth, W. C. Dement, ed.). Saunders: Elsevier; 2011. pp. 54-66.
47. Lal S. K. L., A. Craig. A Critical Review of the Psychophysiology of Driver Fatigue. Biological Psychology. Vol. 55, 2001, pp. 173-194.
48. Sanei S., J. Chambers. EEG Signal Processing. John Wiley & Son, Ltd; West Sussex, England, 2007.
49. Duch W., T. Winiarski, J. Biesiada, A. Kachel. Feature Selection and Ranking Filter. In ICANN and ICONIP Conference. 2003. pp. 251-254.
50. Kohavi R., G. John. Wrappers for Feature Subset Selection. Artificial Intelligence. Vol. 97, 1997, pp. 273-324.
51. Hu J. Automated Detection of Driver Fatigue Based on AdaBoost Classifier with EEG Signals. Frontiers in Computational Neuroscience. Vol. 11, 2017, pp. 72 (10 pages).
52. Hu J. Comparison of Different Features and Classifiers for Driver Fatigue Detection Based on a Single EEG Channel. Computational and Mathematical Methods in Medicine. 2017; pp. 5109530 (9 pages).
53. Shahidi Zandi A., M. Liang, A. Quddus, L. Prest, F. Comeau. Non-Intrusive Assessment of Fatigue in Drivers Using Eye Tracking. Presented at 97th Transportation Research Board, Washington, D.C.; 2018.

1. Use of eye tracking data to determine vigilance.

2. Use of eye tracking data and a classifier to determine vigilance.

3. A method for determining vigilance of a subject, comprising the steps of:
collecting eye tracking data from a plurality of subjects;
independently assessing vigilance of the subjects;
using the eye tracking data and the assessments to train a classifier; and
collecting eye tracking data from the subject and determining vigilance using the trained classifier.

4. A method according to claim 3, wherein the eye tracking data consists of general gaze data including the following:

| | |
|---|---|
| General | Median (heading) |
| Gaze | Median (pitch) |
| | STD* (heading) |
| | STD (pitch) |
| | Scanpath (heading) |
| | Scanpath (pitch) |
| | Velocity ratio (heading) |
| | Velocity ratio (pitch) |
| | Entropy (heading) |
| | Entropy (pitch) |
| | Similarity index |
| Fixation | Duration |
| | Frequency |
| | Percentage |
| | Gaze scanpath (heading) |
| | Gaze scanpath (pitch) |
| | Gaze velocity (heading) |
| | Gaze velocity (pitch) |
| | Gaze similarity index |
| Saccade | Duration |
| | Frequency |
| | Percentage |
| | Gaze scanpath (heading) |
| | Gaze scanpath (pitch) |
| | Gaze velocity (heading) |
| | Gaze velocity (pitch) |
| | Gaze similarity index |
| Blink | Duration |
| | Frequency |
| | Percentage |
| Pupil | Diameter average |
| | Diameter STD |
| Eyelid | Eyelid opening average |
| | Eyelid opening STD |

* standard deviation

5. A method according to claim 3, wherein the eye tracking data is collected in subjects participating in a simulated driving experiment.

6. A method according to claim 3, wherein
vigilance was assessed by power spectral analysis of multichannel electroencephalogram (EEG) signals, recorded simultaneously;
binary labels of alert and drowsy (baseline) were generated for each epoch of the eye tracking data; and
an RF classifier and a non-linear support vector machine were employed for vigilance assessment.
